(19) United States
(12) Patent Application Publication
(10) Pub. No.: US 2023/0296404 A1
(43) Pub. Date: Sep. 21, 2023

(54) SYSTEM AND METHOD FOR UPDATING A MAP ACCORDING TO FEATURE LOCATIONS

(71) Applicant: HERE Global B.V., Eindhoven (NL)

(72) Inventor: Zhenhua ZHANG, Chicago, IL (US)

(21) Appl. No.: 17/700,038

(22) Filed: Mar. 21, 2022

(51) Int. Cl. G01C 21/00

(52) U.S. Cl. CPC G01C 21/3822; G01C 21/3837; G01C 21/3867

(57) ABSTRACT

Provided herein are systems and methods for updating a map. Map data associated with a topology and sensor data corresponding to linear features on the topology are obtained and a key linear feature is identified in the linear features. The method further comprises generating an extension of the key linear feature and identifying a next link segment corresponding to a current link segment of the key linear feature. At least one intersection location between the extended key linear feature and a perpendicular from at least one of (i.) the current link segment or (ii.) the next link segment is determined. A new linear feature location is generated based on the current link segment, the at least one intersection location, and the map data. The map is updated based on the new linear feature location.

### TECHNOLOGICAL FIELD

The present disclosure generally relates to routing and navigation systems, and more particularly relates to methods and systems for updating map data for routing and navigation systems.

### BACKGROUND

Currently, various navigation systems are available for providing navigation assistance. These navigation systems generally request navigation related data or map data of one or more routes from a navigation service. In order to provide precise navigation assistance, the map data utilised should be accurate. Particularly, in the context of autonomous and semi-autonomous vehicle control, it is essential that linear features such as lane marking or road boundary are accurately localized and identified in the map data. The reliability of the map data in this regard comes into question if the linear features are not marked and updated properly in the map. It is desired that the sensor data utilized for constructing and updating the linear features in the map should be accurate. However, in most of cases, the sensor data may not be accurate due one of many reasons such as incorrect sensor detection, duplicate or redundant sensor detections, incorrect reporting of vehicle observations and the like. Also, the linear features may physically erode spatially and temporally and as such refining sensory detections to update them becomes challenging.

Accordingly, a need arises to provide measures, schemes and techniques aimed at alleviating the aforementioned challenges. It is felt that there is a need to provide robust, efficient, and accurate systems and methods for updating maps from sensor detections to reflect intact localization of linear features.

### BRIEF SUMMARY OF SOME EXAMPLE EMBODIMENTS

In navigation contexts, a route may encompass several links and intersections. In order to accurately navigate such routes, it is essential to have a clear understanding of data representing features associated with the links and intersections. That is, the map data utilized to navigate such routes should be a ‘near true’ reflection of the actual topology across which the route passes. In this regard, it is desired that sensory observations should be used to build and update such maps. However, with linear features such as lane markings or road boundaries, it is a challenge to identify them in map since they span across several link segments. One way to do so is by executing the identification process on a segment by segment basis and then integrating the probable linear features of sequential links together. This again faces several challenges since attributes such as heading and location changes from segment to segment and mere generalization of most probable linear features may not help since a feature on one link segment may not match with a feature on another link segment in terms of heading and/or location. The problem amplifies when the segments are part of a curved topology.

Example embodiments described herein are directed towards providing solutions to the aforementioned problems. Some example embodiments provide a framework to reconstruct the linear features from incomplete sensor inputs. Towards this end, it is an object of some example embodiments to extract a key linear feature from a set of linear features corresponding to a topology. Furthermore, some example embodiments describe systems and methods for reconstructing a complete linear feature along a link segment of the topology using the extracted key linear feature and geometrical attributes of the link segment. In order to avoid false positives, some example embodiments provide methods for precisely connecting the key linear features of connecting or subsequent link segments to filter out incorrect linear features, and to inherit the orientation and location features of the link segments. Towards these ends, a system, a method, and a computer program product are provided in accordance with some example embodiments for updating map data of a topology by updating location data of linear features of the topology.

In one aspect, a system for updating a map is disclosed. The system comprises a memory configured to store computer-executable instructions and one or more processors configured to execute the computer-executable instructions. In this regard the one or more processors are configured to obtain map data associated with a topology and sensor data corresponding to a plurality of linear features on the topology. The topology may comprise a plurality of link segments. The one or more processors identify a candidate key linear feature from the plurality of linear features, based on one or more of the map data or at least one characteristic associated with the plurality of linear features. The candidate key linear feature is associated with a current link segment of the plurality of link segments. The one or more processors are further configured to generate an extended key linear feature from the candidate key linear feature by one or more geometrical manipulations of the candidate key linear feature relative to one or more of a start or an end of the current link segment, identify a next link segment corresponding to the current link segment of the candidate key linear feature, based on the map data, and determine at least one intersection location between the extended key linear feature and a perpendicular from at least one of (i) the current link segment or (ii) the next link segment. The one or more processors are further configured to generate a new linear feature location based on the current link segment of the candidate key linear feature, the at least one intersection location, and the map data. The one or more processors update the map data based on the new linear feature location.

In additional system embodiments, in order to identify the candidate key linear feature, the one or more processors are configured to aggregate the plurality of linear features according to heading data and location data of each linear feature of the plurality of linear features and determine a lateral distance between each pair of the aggregated linear features. The linear feature among the plurality of linear features that satisfies a lane width criterion is selected as the candidate key linear feature, based on the lateral distance between each pair of the aggregated linear features.

In additional system embodiments, to generate the extended key linear feature, the one or more processors linearly extend the candidate key linear feature to at least one of the start or the end of the current link segment of the candidate key linear feature by a finite distance such that a total length of the linear extension of the candidate key linear feature is larger than a span of the current link segment. The one or more processors select the linear extension of the candidate key linear feature as the extended key linear feature.

In additional system embodiments, to determine the at least one intersection location, the one or more processors search, for an upstream link segment that is along an upstream heading of the current link, in the map data and search, for a downstream link segment that is along a downstream heading of the current link, in the map data.

In additional system embodiments, if the upstream link segment is absent, the one or more processors are further configured to determine, a first intersection location between a first perpendicular from the start of the current link segment and the extended key linear feature, as the at least one intersection location, wherein the first perpendicular is normal to a heading direction at the start of the current link segment. Alternately, in some system embodiments, if the downstream link segment is absent, the one or more processors are further configured to determine, a second intersection location between a second perpendicular from the end of the current link segment and the extended key linear feature, as the at least one intersection location, wherein the second perpendicular is normal to a heading direction at the end of the current link segment. The one or more processors output one of the first intersection location or the second intersection location as the at least one intersection location.

In additional system embodiments, if at least one of the upstream link segment or the downstream link segment exist for the current link segment, the one or more processors determine a first intersection location between a first perpendicular from an end of the current link segment to the extended key linear feature and determine a second intersection location between a second perpendicular from a start of the next link segment to the extended key linear feature. The first perpendicular is normal to a downstream heading direction of the current link segment and the second perpendicular is normal to a downstream heading direction of the next link segment. The one or more processors output the first intersection location and the second intersection location.

In additional system embodiments, the one or more processors determine a next linear feature associated with the next link segment, based on the map data, determine a finite bounding area defined between a bounding box having parallel sides respectively passing through the first intersection location and the second intersection location, and determine a location corresponding to the next linear feature, based on the map data.

In additional system embodiments, the one or more processors generate an extended next linear feature from the next linear feature by linear extension of the next linear feature towards the extended key linear feature, based on the location corresponding to the next linear feature being within the finite bounding area, and determine a third intersection location of the extended next linear feature and the extended key linear feature as the new linear feature location.

In additional system embodiments, the one or more processors select the second intersection location as the new linear feature location, based on the location corresponding to the next linear feature being outside the finite bounding area.

In another aspect, a method for updating a map is provided. The method comprises obtaining map data associated with a topology and sensor data corresponding to a plurality of linear features on the topology. The method further comprises identifying a candidate key linear feature from the plurality of linear features, based on one or more of the map data or at least one characteristic associated with the plurality of linear features. The candidate key linear feature is associated with a current link segment of the plurality of link segments. The method further comprises generating an extended key linear feature from the candidate key linear feature by one or more geometrical manipulations of the candidate key linear feature relative to one or more of a start or an end of the current link segment. The method further comprises identifying a next link segment corresponding to the current link segment of the candidate key linear feature, based on the map data, determining at least one intersection location between the extended key linear feature and a perpendicular from at least one of (i.) the current link segment or (ii.) the next link segment and generating a new linear feature location based on the current link segment of the candidate key linear feature, the at least one intersection location, and the map data. The map is updated based on the new linear feature location.

In yet another aspect, a computer program product comprising a non-transitory computer readable medium having stored thereon computer executable instructions is provided. The computer executable instructions, when executed by at least one processor, cause the at least one processor to carry out operations for updating a map, the operations comprising: obtaining map data associated with a topology and sensor data corresponding to a plurality of linear features on the topology. The operations further comprise identifying a candidate key linear feature from the plurality of linear features, based on one or more of the map data or at least one characteristic associated with the plurality of linear features. The candidate key linear feature is associated with a current link segment of the plurality of link segments. The operations further comprise generating an extended key linear feature from the candidate key linear feature by one or more geometrical manipulations of the candidate key linear feature relative to one or more of a start or an end of the current link segment, identifying a next link segment corresponding to the current link segment of the candidate key linear feature, based on the map data, and determining at least one intersection location between the extended key linear feature and a perpendicular from at least one of (i.) the current link segment or (ii.) the next link segment. The operations further comprise generating a new linear feature location based on the current link segment of the candidate key linear feature, the at least one intersection location, and the map data and updating the map data based on the new linear feature location.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1A illustrates a block diagram showing a network environment of a system for updating a map, in accordance with one or more example embodiments;

FIG. 1B illustrates a block diagram showing map data, in accordance with one or more example embodiments;

FIG. 1C illustrates another block diagram showing map data, in accordance with one or more example embodiments;

FIG. 1D illustrates yet another block diagram showing map data, in accordance with one or more example embodiments;

FIG. 2 illustrates a block diagram of the system for updating map data, in accordance with one or more example embodiments;

FIG. 3 illustrates a graphical user interface illustrating generalized representations of lane marking centroids, in accordance with one or more example embodiments;

FIG. 4A illustrates a generalized framework for updating linear features in a map, in accordance with one or more example embodiments;

FIG. 4B illustrates a flowchart illustrating some steps of the framework for updating linear features in a map, in accordance with one or more example embodiments;

FIG. 5A illustrates a flowchart of a method for identifying a candidate key linear feature for a topology, in accordance with one or more example embodiments;

FIG. 5B illustrates a schematic diagram showing linear features and lane width between the linear features, according to some example embodiments;

FIG. 6A shows link level composition of the topology, in accordance with one or more example embodiments;

FIG. 6B illustrates a schema for generating an extended key linear feature for the topology, in accordance with an example embodiment;

FIG. 6C illustrates a schema for generating an extended key linear feature for the topology, in accordance with another example embodiment;

FIG. 6D illustrates a flowchart of a method for determining at least one intersection location for generating a new feature location, in accordance with a first example embodiment;

FIG. 7A illustrates a schema for generating the new feature location, in accordance with an example embodiment;

FIG. 7B illustrates a schema for generating the new feature location, in accordance with another example embodiment;

FIG. 7C illustrates a flowchart of a method for generating the new feature location, in accordance with one or more example embodiments;

FIG. 7D and FIG. 7E illustrate a filtering schema for removing outlier locations from the computation of the new feature location, in accordance with one or more example embodiments; and

FIG. 8 illustrates an exemplar working scenario for updating map data, in accordance with one or more example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for reconstructing linear features of a topology from incomplete sensor data acquired by user equipment. In essence the systems and methods provided herein, update the data stored in a map database with the reconstructed linear features. Navigation assistance based on the updated map data, when provided to users, is precise, accurate, and a near true representation of the features of the topology. In other words, the map data is rich and highly complete in terms of amount of information it provides and accuracy of the information it provides. Thus, example embodiments disclosed herein provide several tangible improvements to the field of mapping and navigation technology. Furthermore, example embodiments do not require any separate data acquisition other than normal road observations from the sensors of user equipment. This reduces the complexity of the update process and reduces the processing burden. The systems and methods that accomplish these and several additional objectives will now be described in conjunction with aid of various figures.

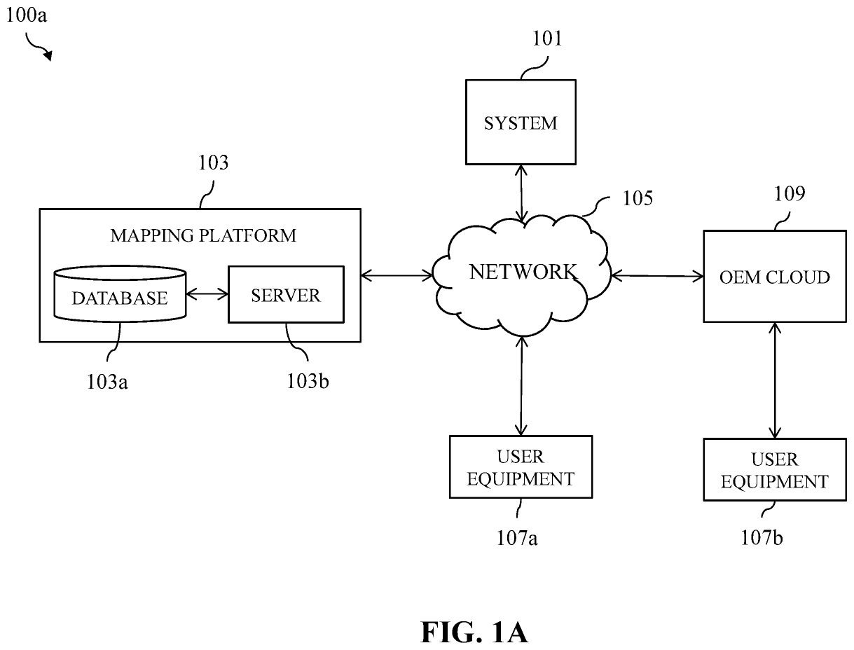

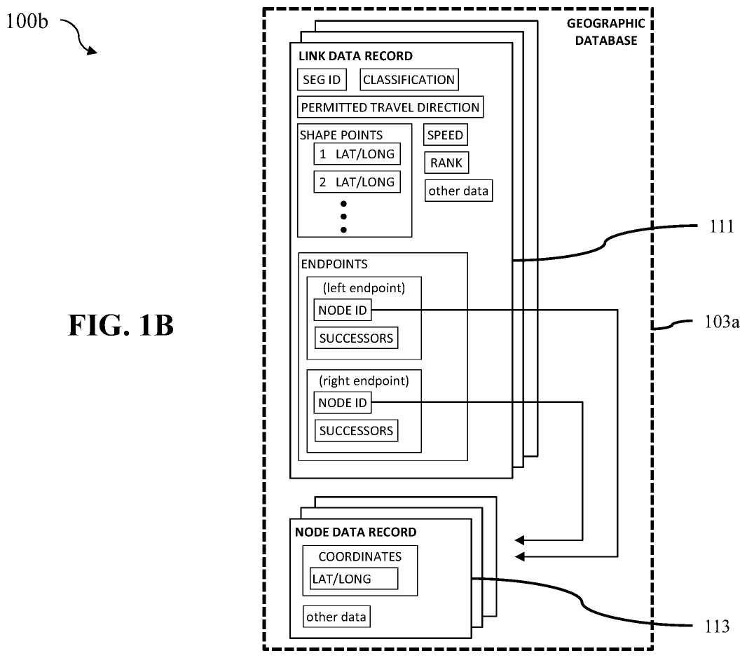

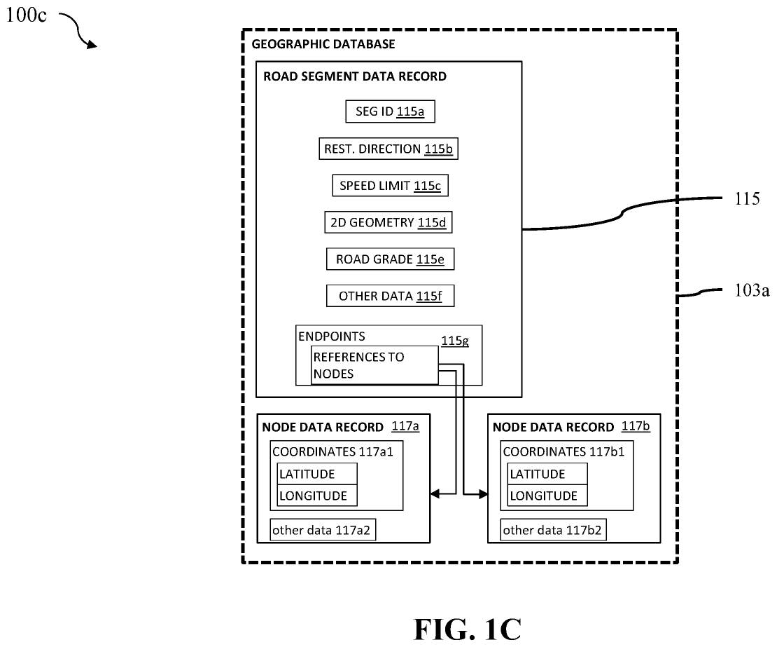

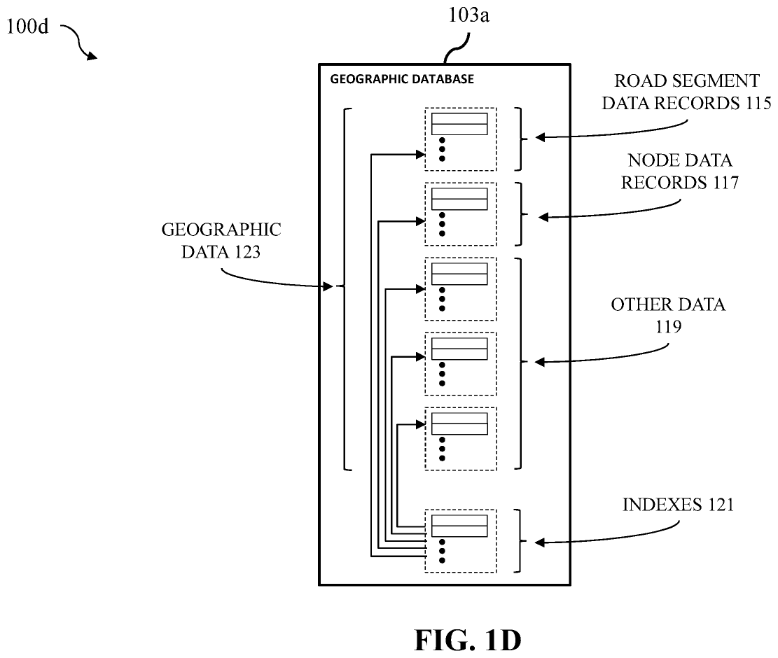

FIG. 1A illustrates a block diagram showing a network environment 100a of a system 101 for identifying redundant road lane detections, in accordance with one or more example embodiments. The system 101 may be communicatively coupled, via a network 105, to one or more of a mapping platform 103, a user equipment 107a, and/or an OEM (Original Equipment Manufacturer) cloud 109. The OEM cloud 109 may be connected to the user equipment 107b. The components described in the block diagram 100a may be further broken down into more than one component such as one or more sensors or application in user equipment and/or combined together in any suitable arrangement. Further, it is possible that one or more components may be rearranged, changed, added, and/or removed without deviating from the scope of the present disclosure.

In an example embodiment, the system 101 may be embodied in one or more of several ways as per the required implementation. For example, the system 101 may be embodied as a cloud-based service, a cloud-based application, a cloud-based platform, a remote server-based service, a remote server-based application, a remote server-based platform, or a virtual computing system. As such, the system 101 may be configured to operate inside the mapping platform 103 and/or inside at least one of the user equipment 107a and the user equipment 107b.

In some embodiments, the system 101 may be embodied within one or both of the user equipment 107a and the user equipment 107b, for example as a part of an in-vehicle navigation system, a navigation app in a mobile device and the like. In each of such embodiments, the system 101 may be communicatively coupled to the components shown in FIG. 1A to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. In an embodiment, the system 101 may be deployed in a consumer vehicle or a probe vehicle, and/or a ground truth collection vehicle to collect sensor data for specifically updating the road lane detection data associated the mapping platform 103.

In some other embodiments, the system 101 may be embodied as a server 103b of the mapping platform 103 and therefore may be co-located with or within the mapping platform 103. In yet some other embodiments, the system 101 may be implemented within an OEM (Original Equipment Manufacturer) cloud, such as the OEM cloud 109. The OEM cloud 109 may be configured to anonymize any data received from the system 101, such as the vehicle, before using the data for further processing, such as before sending the data to the mapping platform 103. In some embodiments, anonymization of data may be done by the mapping platform 103. Further, in some example embodiments, the system 101 may be a standalone unit configured to update the road lane detection data for an autonomous vehicle. Additionally, the system 101 may be coupled with an external device such as the autonomous vehicle.

The mapping platform 103 may comprise a map database 103a (also referred to as geographic database 103a) for storing map data and a processing server 103b for carrying out the processing functions associated with the mapping platform 103. The map database 103a may store node data, road segment data or link data, point of interest (POI) data, road obstacles related data, traffic objects related data, posted signs related data, such as road sign data, lane marking data such as road lane detection data or the like. The map database 103a may also include cartographic data and/or routing data. According to some example embodiments, the link data may be stored in link data records, where the link data may represent links or segments representing roads, streets, or paths, as may be used in calculating a route or recorded route information for determination of one or more personalized routes. The node data may be stored in node data records, where the node data may represent end points corresponding to the respective links or segments of the road segment data. One node represents a point at one end of the respective link and the other node represents a point at the other end of the respective link. The node at either end of a link corresponds to a location at which the road meets another road, e.g., an intersection, or where the road dead ends. An intersection may not necessarily be a place at which a turn from one road to another is permitted but represents a location at which one road and another road have the same latitude, longitude, and elevation. In some cases, a node may be located along a portion of a road between adjacent intersections, e.g., to indicate a change in road attributes, a railroad crossing, or for some other reason. (The terms “node” and “link” represent only one terminology for describing these physical geographic features and other terminology for these features is intended to be encompassed within the scope of these concepts.) The link data and the node data may represent a road network used by vehicles such as cars, trucks, buses, motorcycles, and/or other entities.

Additionally, the map database 103a may contain path segment and node data records, or other data that may represent pedestrian paths or areas in addition to or instead of the vehicle road record data, for example. The links/road segments and nodes may be associated with attributes, such as geographic coordinates and other navigation related attributes, as well as POIs, such as fuelling stations, hotels, restaurants, museums, stadiums, offices, auto repair shops, buildings, stores, parks, etc. The navigation related attributes may include one or more of travel speed data (e.g. data indicative of a permitted speed of travel) on the road represented by the link data record, a travel direction data (e.g. data indicative of a permitted direction of travel) on the road represented by the link data record, the linear feature data on the road represented by the link data record, the road lane detection data on the road represented by the link data record, street address ranges of the road represented by the link data record, the name of the road represented by the link data record, and the like.

As used herein, the ‘road lane detection data’ may be data indicative of lane markings on the link or the road or may be related to any linear feature along the road represented by the link data record. The linear feature may be at least one of lane markings, road curbs, guardrails, road medians, road barriers, and the like along the road. The lane markings may be of an alternate colour in contrast to the colour of surface of the road. In some example embodiments, lane markings are yellow in colour, such as when they are used to indicate roadwork zones. The road lane detection data may be captured by an image capturing device, such as a camera, installed in the vehicle traversing the link to generate a road lane detection. The vehicle may also include one or more other sensors as well for generating the road lane detections. The sensors in the vehicle may transmit the generated lane marking observations to the OEM cloud 109 sequentially.

These road lane detections are used further to update map data of the map database 103a. The map database 103a also stores various navigation related attributes associated with a link that may be stored in a single data record or may be stored in more than one type of record.

Each link data record that represents other-than-straight link (for example, a curved link) may include shape location data. A shape location is a location along a link between its endpoints. For instance, to represent the shape of other-than-straight roads/links, a geographic database developer may select one or more shape locations along the link portion. The shape location data included in the link data record may indicate a position, (e.g., latitude, longitude, and optionally, altitude or elevation) of the selected shape point(s) along the represented link.

Additionally, the map database 103a may also include data about the POIs and their respective locations in the POI records. The map database 103a may further include data about places, such as cities, towns, or other communities, and other geographic features such as bodies of water, mountain ranges, etc. Such place or feature data may be part of the POI data or may be associated with POIs or POI data records (such as a data point used for displaying a city). In addition, the map database 103a may include event data (e.g., traffic incidents, construction activities, scheduled events, unscheduled events, etc.) associated with the POI data records or other records of the map database 103a.

The map database 103a may be maintained by a content provider e.g., a map developer. By way of example, the map developer may collect the map data to generate and enhance the map database 103a. There may be different ways used by the map developer to collect data. These ways may include obtaining data from other sources, such as municipalities or respective geographic authorities. In addition, the map developer may employ field personnel to travel by vehicle (also referred to as a dedicated vehicle) along roads throughout a geographic region to observe features and/or record information about them, for example. Also, remote sensing, such as aerial or satellite photography, may be used to collect the map data. In some example embodiments, the map data in the map database 103a may be stored as a digital map. The digital map may correspond to satellite raster imagery, bitmap imagery, or the like. The satellite raster imagery/bitmap imagery may include map features (such as link/road segments, nodes, and the like) and the navigation related attributes associated with the map features. In some embodiments, the map features may have a vector representation form. Additionally, the satellite raster imagery may include three-dimensional (3D) map data that corresponds to 3D map features, which are defined as vectors, voxels, or the like.

According to some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, the map data may be compiled (such as into a platform specification format (PSF format)) to organize and/or configure the data for performing navigation-related functions and/or services, such as route calculation, route guidance, map display, speed calculation, distance and travel time functions, navigation instruction generation and other functions, by a navigation device, such as by the user equipment 107a and/or 107b. The navigation-related functions may correspond to vehicle navigation, pedestrian navigation, navigation instruction suppression, navigation instruction generation based on user preference data or other types of navigation. The compilation to produce the end user databases may be performed by a party or entity separate from a map developer. For example, a customer of the map developer, such as a navigation device developer or other end user device developer, a navigation app service provider and the like may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment such as the user equipment 107a and/or the user equipment 107b to provide navigation and/or map-related functions. For example, the map database 103a may be used with the user equipment 107a and/or the user equipment 107b to provide an end user with navigation features. In such a case, the map database 103a may be downloaded or stored locally (cached) on the user equipment 107a and/or the user equipment 107b.

The processing server 103b may comprise processing means, and communication means. For example, the processing means may comprise one or more processors configured to process requests received from the user equipment 107a and/or the user equipment 107b. The processing means may fetch map data from the map database 103a and transmit the same to the user equipment 107b via the OEM cloud 109 in a format suitable for use by the one or both of the user equipment 107a and/or the user equipment 107b. In one or more example embodiments, the mapping platform 103 may periodically communicate with the user equipment 107a and/or the user equipment 107b via the processing server 103b to update a local cache of the map data stored on the user equipment 107a and/or the user equipment 107b. Accordingly, in some example embodiments, the map data may also be stored on the user equipment 107a and/or the user equipment 107b and may be updated based on periodic communication with the mapping platform 103 via the network 105.

The network 105 may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In some example embodiments, the user equipment 107a and the user equipment 107b may be any user accessible device such as a mobile phone, a smartphone, a portable computer, and the like that are portable in themselves or as a part of another portable/mobile object such as a vehicle. The user equipment 107a and 107b may comprise a processor, a memory, and a communication interface. The processor, the memory, and the communication interface may be communicatively coupled to each other. In some example embodiments, the user equipment 107a and 107b may be associated, coupled, or otherwise integrated with a vehicle, such as an advanced driver assistance system (ADAS), a personal navigation device (PND), a portable navigation device, an infotainment system and/or other device that may be configured to provide route guidance and navigation related functions to the user. In such example embodiments, the user equipment 107a and 107b may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 107a and 107b. For example, the user equipment 107a and 107b may be configured to execute and run mobile applications such as a messaging application, a browser application, a navigation application, and the like.

In one embodiment, at least one user equipment such as the user equipment 107a may be directly coupled to the system 101 via the network 105. For example, the user equipment 107a may be a dedicated vehicle (or a part thereof) for gathering data for development of the map data stored in the map database 103a. In another embodiment, at least one user equipment such as the user equipment 107b may be coupled to the system 101 via the OEM cloud 109 and the network 105. For example, the user equipment 107b may be a consumer vehicle (or a part thereof) and may be a beneficiary of the services provided by the system 101. In some example embodiments, one or more of the user equipment 107a and 107b may serve the dual purpose of a data gatherer and a beneficiary device. At least one of the user equipment 107a and 107b may be configured to capture sensor data associated with the link/road segment, while traversing along the link/road segment. For example, the sensor data may include image data associated with road lane detections along the link/road segment, among other things. The sensor data may be collected from one or more sensors in the user equipment 107a and/or user equipment 107b. As disclosed in conjunction with various embodiments disclosed herein, the system 101 may update the linear feature data using the sensor data.

FIG. 1B shows format of the map data 100b stored in the map database 103a according to one or more example embodiments. FIG. 1B shows a link data record 111 that may be used to store data about one or more of the road links. This link data record 111 has information (such as “attributes”, “fields”, etc.) associated with it that allows identification of the nodes associated with the road link and/or the geographic positions (e.g., the latitude and longitude coordinates and/or altitude or elevation) of the two nodes. In addition, the link data record 111 may have information (e.g., more “attributes”, “fields”, etc.) associated with it that specify the permitted speed of travel on the portion of the road represented by the link data record 111, the direction of travel permitted on the road portion represented by the link data record 111, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 111 indicate the position, (e.g., latitude, longitude, and optionally, altitude or elevation) of the selected shape points along the represented road link.

Additionally, in the compiled geographic database, such as a copy of the map database 103a that is compiled and provided to the user, there may also be a node data record 113 for each node. The node data record 113 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 1C shows another format of the map data 100c stored in the map database 103a according to one or more example embodiments. In the FIG. 1C, the map data 100c is stored by specifying a road segment data record 115. The road segment data record 115 is configured to represent data that represents a road network. In FIG. 1C, the map database 103a contains at least one road segment data record 115 (also referred to as “entity” or “entry”) for each road segment in a geographic region.

The map database 103a that represents the geographic region also includes a database record 117 (a node data record 117a and a node data record 117b) (or “entity” or “entry”) for each node associated with the at least one road segment shown by the road segment data record 115. (The terms “nodes” and “segments” represent only one terminology for describing these physical geographic features and other terminology for describing these features is intended to be encompassed within the scope of these concepts). Each of the node data records 117a and 117b may have associated information (such as “attributes”, “fields”, etc.) that allows identification of the road segment(s) that connect to it and/or its geographic position (e.g., its latitude and longitude coordinates).

FIG. 1C also shows some of the components of the road segment data record 115 contained in the map database 103a. The road segment data record 115 includes a segment ID 115a by which the data record can be identified in the map database 103a. Each road segment data record 115 has associated with it information (such as “attributes”, “fields”, etc.) that describes features of the represented road segment. The road segment data record 115 may include data 115b that indicate the restrictions, if any, on the direction of vehicular travel permitted on the represented road segment. The road segment data record 115 includes data 115c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 115 may also include data 115d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 115 also includes road grade data 115e that indicate the grade or slope of the road segment. In one embodiment, the road grade data 115e include road grade change points and a corresponding percentage of grade change. Additionally, the road grade data 115e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 115e includes the road grade change points and an actual road grade value for the portion of the road segment after the road grade change point until the next road grade change point or end node. In a further embodiment, the road grade data 115e includes elevation data at the road grade change points and nodes. In an alternative embodiment, the road grade data 115e is an elevation model which may be used to determine the slope of the road segment.

The road segment data record 115 also includes data 115g providing the geographic coordinates (e.g., the latitude and longitude) of the end points of the represented road segment. In one embodiment, the data 115g are references to the node data records 115 that represent the nodes corresponding to the end points of the represented road segment.

The road segment data record 115 may also include or be associated with other data 115f that refer to various other attributes of the represented road segment. The various attributes associated with a road segment may be included in a single road segment record or may be included in more than one type of record which cross-reference each other. For example, the road segment data record 115 may include data identifying the name or names by which the represented road segment is known, the street address ranges along the represented road segment, and so on.

FIG. 1C also shows some of the components of the node data record contained in the map database 103a. Each of the node data records may have associated information (such as “attributes”, “fields”, etc.) that allows identification of the road segment(s) that connect to it and/or it's geographic position (e.g., its latitude and longitude coordinates). For the embodiment shown in FIG. 1C, the node data records 117a and 117b include the latitude and longitude coordinates 117a1 and 117b1 for their nodes. The node data records 117a and 117b may also include other data 117a2 and 117b2 that refer to various other attributes of the nodes. In some embodiments, the node data records 117a and 117b may be associated with at least one first point and at least one second point, which may be border points of a road lane detection associated with the road link line to be generated.

Thus, the overall data stored in the map database 103a may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 103a in the formats shown in FIGS. 1B and 1C may be combined in a suitable manner to provide these three or more layers of information. In some embodiments, there may be lesser or fewer number of layers of data also possible, without deviating from the scope of the present disclosure.

FIG. 1D illustrates a block diagram 100d of the map database 103a storing map data or geographic data 123 in the form of road segments/links, nodes, and one or more associated attributes as discussed above. Furthermore, attributes may refer to features or data layers associated with the link-node database, such as an HD lane data layer.

In addition, the map data 123 may also include other kinds of data 119. The other kinds of data 119 may represent other kinds of geographic features or anything else. The other kinds of data may include point of interest data. For example, the point of interest data may include point of interest records comprising a type (e.g., the type of point of interest, such as restaurant, hotel, city hall, police station, historical marker, ATM, golf course, etc.), location of the point of interest, a phone number, hours of operation, etc. The map database 103a also includes indexes 121. The indexes 121 may include various types of indexes that relate the different types of data to each other or that relate to other aspects of the data contained in the geographic database 103a.

The data stored in the map database 103a in the various formats discussed above may help in provide precise data for high-definition mapping applications, autonomous vehicle navigation and guidance, cruise control using ADAS, direction control using accurate vehicle maneuvering and other such services. In some embodiments, the system 101 accesses the map database 103a storing data in the form of various layers and formats depicted in FIGS. 1B-1D, to provide accurate road lane detection data.

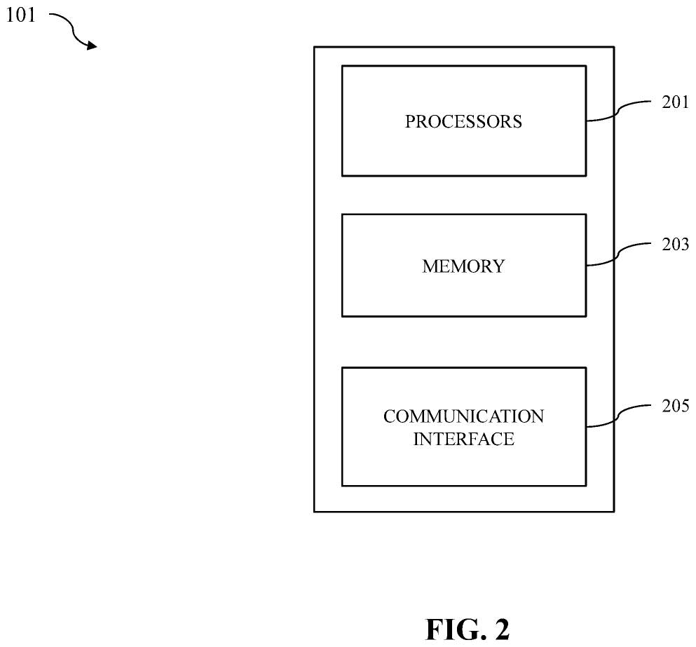

FIG. 2 illustrates a block diagram 200 of the system 101 for implementing one or more functionalities, in accordance with one or more example embodiment. The system 101 may include one or more processors 201 (or simply processor 201), a memory 203, and a communication interface 205. The system 101 may perform computations for reconstructing linear features using map data and sensor data. In this regard, the processor 201 may control the communication interface 205 to receive and obtain data for processing. In a similar manner, the processor 201 may control the communication interface 205 to transmit or broadcast data for external recipients. The components of the system 101 may be operationally coupled using suitable connects such as buses to facilitate swift transfer of signalling among the components of the system 101.

In an embodiment, the processor 201 may be configured to obtain the sensor data associated with road observations. The sensor data may be obtained from one or more user equipment, such as the user equipment 107a, the user equipment 107b and the like. The sensor data may also be obtained from the one or more user equipment installed in a vehicle (such as the consumer or “probe” vehicle; or the dedicated data collection vehicle discussed briefly earlier). The vehicle may be equipped with one or more sensors such as a camera, an acceleration sensor, a gyroscopic sensor, a LIDAR sensor, a proximity sensor, a motion sensor, and the like.

The sensors may detect road observation data including road lane data, also interchangeably referred to as road lane detections, and position data of the vehicle. The sensors may be built-in or embedded into or within interior of the user equipment associated with the vehicle. In some embodiments, the user equipment 107a or 107b uses communication signals for position determination of the vehicle. The user equipment 107a or 107b may receive location data from a positioning system, a Global Navigation Satellite System, such as Global Positioning System (GPS), Galileo, GLONASS, BeiDou, etc., cellular tower location methods, access point communication fingerprinting such as Wi-Fi or Bluetooth based radio maps, or the like. The data collected by the sensors in the vehicle may be used to gather information related to an environment of the vehicle, such as, the road lane detection data, the distance of the vehicle from the road lane boundary or lane marking, the lateral placement of the vehicle on the road link, and the like. In some embodiments, the sensors positioned on or within and the user equipment 107a or 107b may provide data indicating a location of the vehicle and a heading data value associated with the vehicle, a road lane detection heading value associated with the road lane detection, and the like. The data collected by the sensors may be transmitted to the OEM cloud 109. Vehicle or sensor data may be collected by any device capable of determining the necessary information and providing the necessary information to a remote entity. The user equipment 107a or 107b is one example of a device that may function as a probe to collect probe data of the vehicle. The data captured by the sensors from one or more vehicles, as obtained by the processor 201 may have several inaccuracies and redundancies due to some of the reasons described earlier, and thus, may be subject to refinement and processing.

The processor 201 may obtain data related to one or more features and entities on a road, a route and/or a region that may be of interest. In this regard, the processor 201 may access the map database 103a and request data for further processing. As discussed previously, the map database 103a stores data with different granularity for features and objects in a region. A topology comprises a plurality of links that connect two intersections. Each link in turn may be fragmented into one or more link segments depending on some condition such as a change in heading direction along the link or when length of a segment exceeds a threshold. In some example embodiments, the link may correspond to a road and the link segments in such cases correspond to road segments of the road. In some other example embodiments, the link may take the form of alleys, arteries, tubes, tunnels or any other form of passage. In the course of processing data for reconstructing linear features, the processor 201 may request map data regarding a plurality of entities. The processor 201 may retrieve computer-executable instructions that may be stored in the memory 203, which when executed configure the processor 201 for updating the linear feature data.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

Additionally, or alternatively, the processor 201 may include one or more processors capable of processing large volumes of workloads and operations to provide support for big data analysis. In an example embodiment, the processor 201 may be in communication with the memory 203 via a bus for passing information to mapping platform 103. The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the system 101 to carry out various functions in accordance with an example embodiment of the present disclosure. For example, the memory 203 may be configured to buffer input data for processing by the processor 201.

As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present disclosure while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

In some embodiments, the processor 201 may be configured to provide Internet-of-Things (IoT) related capabilities to a user of the system 101, where the user may be a traveller, a driver of the vehicle and the like. In some embodiments, the user may be or correspond to an autonomous or semi-autonomous vehicle. The IoT related capabilities may in turn be used to provide smart navigation solutions by providing real time updates to the user to take pro-active decision on lane maintenance, speed determination, lane-level speed determination, turn-maneuvers, lane changes, overtaking, merging and the like. The system 101 may be accessed using the communication interface 205. The communication interface 205 may provide an interface for accessing various features and data stored in the system 101. For example, the communication interface 205 may comprise I/O interface which may be in the form of a GUI, a touch interface, a voice enabled interface, a keypad, and the like. For example, the communication interface 205 may be a touch enabled interface of a navigation device installed in a vehicle, which may also display various navigation related data to the user of the vehicle. Such navigation related data may include information about upcoming conditions on a route, route display and alerts about lane maintenance, turn-maneuvers, vehicle speed, and the like.

The various modules of the processor 201, in conjunction with the memory 203 and communication 205 may provide capabilities and advantages to the system 101 to produce high quality data for reliable and secure navigation applications, which was not possible with existing solutions known in the art. Some of these advantages are possible due to reconstruction of the linear features that may have been improperly localised and identified in the map, which otherwise poses many safety and reliability related challenges while navigation, specifically in autonomous vehicles or vehicles based on high-definition fast maps.

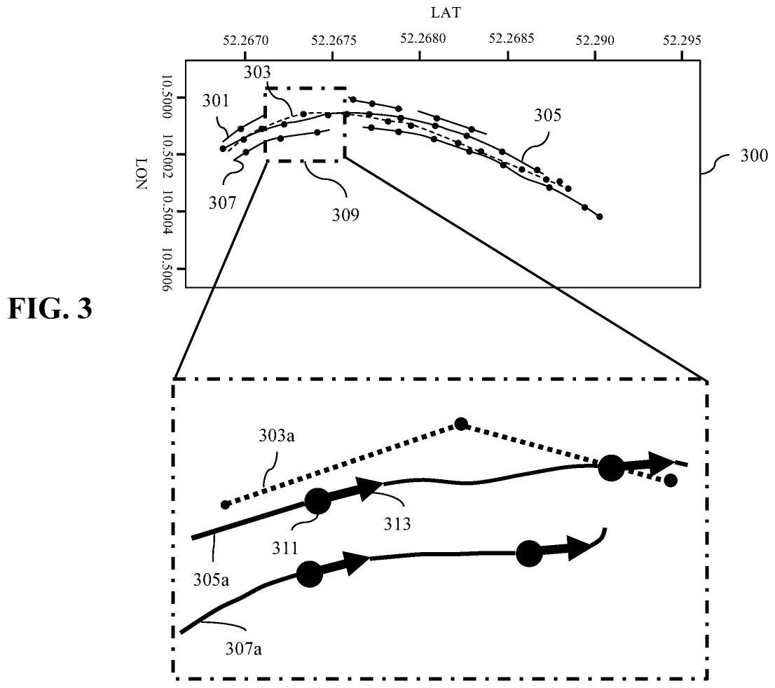

FIG. 3 illustrates a graphical user interface illustrating generalized representations of lane marking centroids, according to some example embodiments. A graphical user interface such as a screen of a user equipment may display a layout 300 of the map of a region. The layout 300 may depict representation of a linear feature detection such as lane marking detections as provided by sensor inputs and as provided by map data, on segments of a plurality of links in a two dimensional (2D) grid. The links may be a part of a route connecting two or more intersections. The 2D grid may for example have latitude and longitude as axes wherein each point on a link segment may be represented as a Cartesian coordinate in terms of its corresponding latitude and longitude. In the layout 300, the representations 301, 305 and 307, which are shown as dark continuous lines, correspond to the lane marking detections provided by sensor inputs while the representation 303, shown as dotted line, corresponds to lane markings as indicated by map data.

An enlarged view of a portion 309 of the layout 300 illustrates representations 303a, 305a, and 307a, each having a plurality of lane marking centroids. In mapping terminology, a topology refers to a set of link segments that connect two intersections. Each link segment in the set of link segments comprises at least two shape locations. A linear feature may be generalized and stored, for example in map database 103a, as a combination of location and heading. For example, the dot 311 on representation 305a may correspond to a generalized location and the arrow 313 may indicate a heading direction of the corresponding link segment. Such a combination of location and heading may be used to indicate an orientation of a linear feature such as lane marking. That is, when performing linear feature detection, in order to pair a feature with corresponding link segment, the orientation data (obtained from map) of a corresponding link segment may be used.

As is observed, FIG. 3 is an illustration of a scenario where there appears mismatch between feature detections as provided by map data and as provided by sensor inputs. For lane marking detections on the same link segment, the most probable linear features may be generalized as a combination of location and heading shown in FIG. 3. However, such probable features are not directly connectable when features exist on connecting link segments. Also, it is a challenge to construct an intact linear feature along the topology, especially when the topology is curved. In order to address these issues, provided herein are systems, methods, and compute program products for generating an updated map.

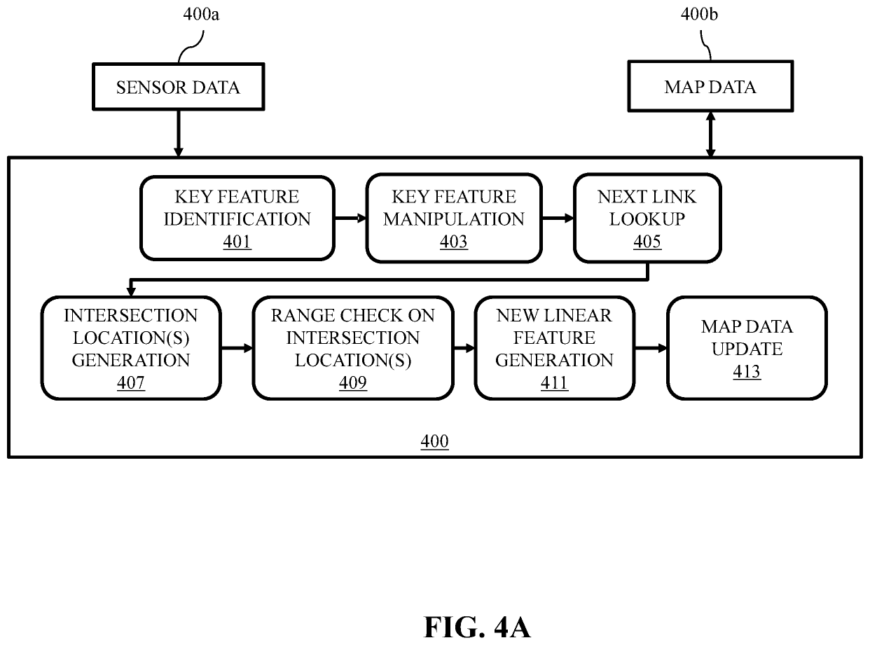

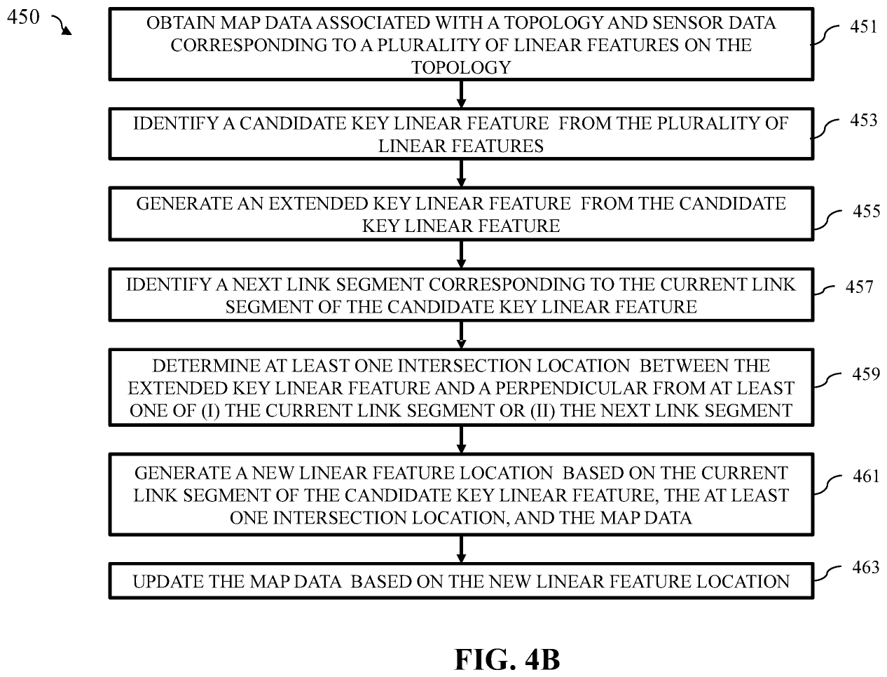

FIG. 4A illustrates a generalized framework 400 for updating linear features in a map according to some example embodiments. The framework 400 may operate on sensor data 400a provided as inputs from user equipment or vehicles, wherein the sensor inputs may be raw or incomplete in terms of the road observations that they make. The framework 400 also utilizes map data 400b for performing reconstruction of linear features and updates the map data based on the reconstructed linear features.

The framework 400 comprises a key feature identification stage 401 for identifying a key linear feature from all the linear features that are on the same topology. The framework 400 also comprises a key feature manipulation stage 403 for generating an extended key linear feature from the identified key linear feature. The framework 400 further comprises a next link lookup stage 405 for determining a next link associated with the identified key linear feature and an intersection location(s) generation stage 407 for determining at least one intersection location between the extended key linear feature and one or more of (i.) the current link segment of the key linear feature or (ii.) the next link segment. The framework 400 also comprises an optional range check on intersection location(s) stage 409 for filtering outliers and false positives for the determined intersection location(s), a new linear feature generation stage 411 for reconstructing the next linear feature for the identified key linear feature, and a map data update stage 413 for updating the map data of the topology with the generated new linear feature. Each stage of the framework 400 is described in relation with flowcharts and schematic diagrams illustrated in FIGS. 4B-7E.

FIG. 4B illustrates a flowchart illustrating some steps of the framework for updating linear features in a map, in accordance with one or more example embodiments. It will be understood that each block of the flow diagram of the method 900 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 203 of the system 101, employing an embodiment of the present invention and executed by the processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow chart support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Specifically, FIG. 4B provides a method 450 for updating the map data. Towards this end, method 450 comprises obtaining 451 map data associated with a topology and sensor data corresponding to a plurality of linear features on the topology. The sensor data may include data captured by user equipment such as one or more vehicles' on-board sensors, while travelling on a route comprising one or more road links (or simply links). In some example embodiments, the sensor data may be received as road observations associated with plurality of linear features such as lane markings corresponding to one or more lanes on a road link represented by map data. The road observations may be captured by one or more sensors including, but not limited to, a camera, a LIDAR sensor, a proximity sensor, a positioning sensor and the like. The road observations may be associated with road observation data, such as data about location at which the road observation on the link or on the map is made expressed in terms of its location coordinates, timestamp associated with capturing of the sensor data associated with the road observations, lateral position data for the road observation, image data of the road observation, length of the road observation, heading data associated with the road observation and the like. The map data may be fetched in any suitable manner from a repository such as the map database 103a or an on board storage. In some example embodiments, the on board storage may store a local cache of the map data of the topology or a region encompassed by the topology.

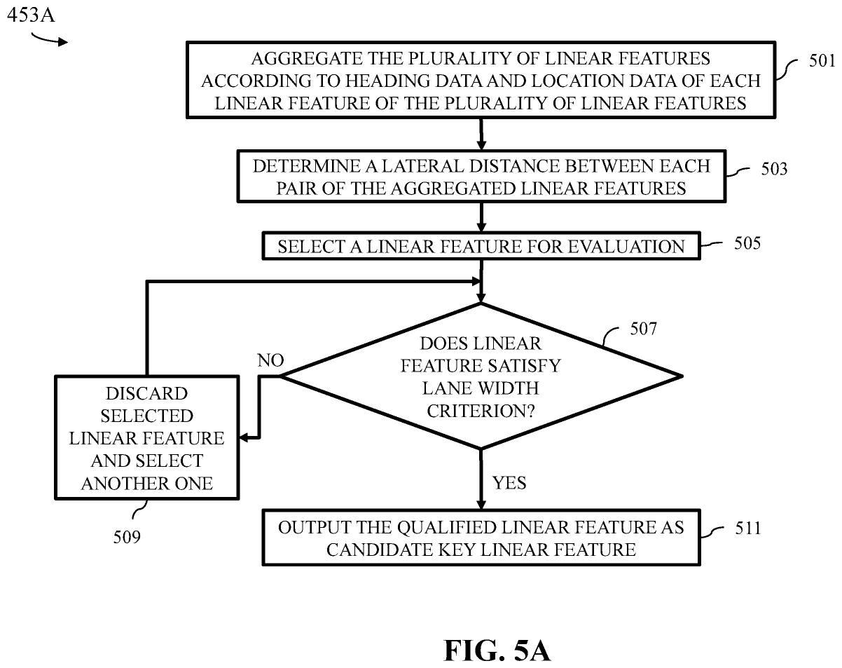

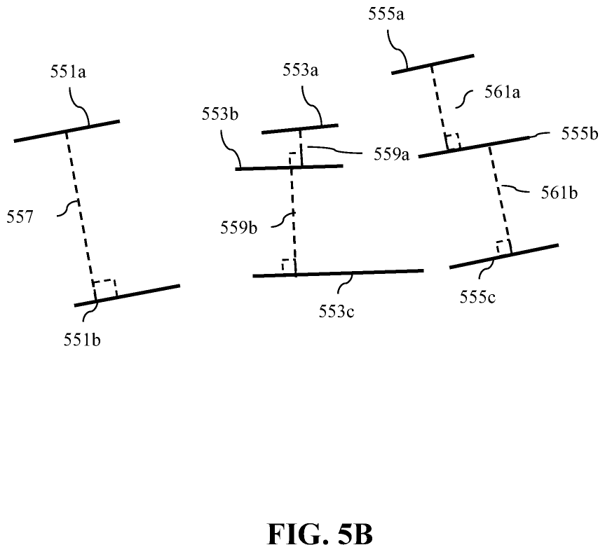

The method 450 further comprises identifying 453 a candidate key linear feature from among the plurality of linear features of the topology. This is explained in detail next with reference to FIG. 5A which illustrates a flowchart of a method 453A for identifying a candidate key linear feature for a topology, in accordance with one or more example embodiments. A key linear feature may be considered as the feature that has a width closest to the most probable lane width for the corresponding link segment as stored in map data. In order to identify which linear feature is a key linear feature, it is required that the width of the corresponding link segment be fetched from the map data and the width of all the linear features be computed. In this regard, method 453A, comprises aggregating 501 the plurality of linear features according to heading data and location data of each linear feature of the plurality of linear features. Using map data associated with the topology and sensor data corresponding to the linear features on the topology, the linear features are aggregated. according to heading data and location data of each linear feature. For aggregating in terms of location, the aggregation is for the signed distance from the linear feature location to corresponding matched location on the map link. For instance, if the feature is on the left of the map and its distance to map is 3 meters, its signed distance is −3 and if it is on the right of the map and its distance to map is 3 meters, its signed distance is 3. Linear features with the similar signed distance may be taken as on the same row while linear features in different rows may be used to generate the lane width information. For aggregating in terms of heading, the heading difference between the linear feature and the corresponding map link for the linear feature is determined. The aggregation takes the median value of all the heading differences on the same segment to eliminate the variations. In this regard, a tolerance range or value may be defined to eliminate the variations.

The method 453A further comprises at 503, determining a lateral distance between each pair of the aggregated linear features. At 503, a median lane width is calculated based on all the lane widths on the same segment. FIG. 5B illustrates a schematic diagram showing linear features and lane width between the linear features, according to some example embodiments. Given a linear feature, a line may be extended from the linear feature's center location perpendicular to another nearby linear feature. The length between the subject linear feature's center location and the intersected location of that line on its nearby linear feature may be calculated as the distance between the subject linear feature and its nearby linear feature. When calculating the distance of all linear features on the same topology, the nearby linear features should always be on either their right side or left side. The distance between a subject linear feature and its nearby linear features may be taken as the lane width candidate of the subject linear feature only when the intersected location is on the nearby linear features and the distance is within a threshold range. The threshold range may be defined based on one or more performance metrics associated with the system. In some example embodiments, the threshold may be defined in terms of ground truth data for the road segment such that the lane width is as close to actual lane width on the road. For example, in some non-limiting example embodiments, the lower limit of the threshold range for the lane width may be selected to be 1.6 m while the upper limit of the threshold range for the lane width may be selected as 7 m.

As is shown in FIG. 5B, linear features 551a and 551b form a feature pair of subject linear feature and nearby linear feature. Similar such pairs may exist as linear features 553a and 553b, linear features 553b and 553c, linear features 555a and 555b, and linear features 555b and 555c. Line 557 may correspond to the lane width for the linear feature pairs 551a and 551b. Likewise, line 559a may correspond to the lane width for the linear feature pairs 553a and 553b, line 559b may correspond to the lane width for the linear feature pairs 553b and 553c, line 561a may correspond to the lane width for the linear feature pairs 555a and 555b, and line 561b may correspond to the lane width for the linear feature pairs 555b and 555c. In some example embodiments, the lane width 557 may be outside the upper limit of threshold range and as such the linear feature may be discarded for further processing. In some example embodiments, lane width 559a may be lower than the lower limit of the threshold range and may also be discarded from further processing. Lane widths 559b, 561a and 561b may be within the threshold range and may therefore be selected for further processing.

Returning to FIG. 5A, at step 505, a linear feature is picked for evaluation to be performed at 507. At 507, a check is performed as to whether the corresponding lane width of the linear feature matches a lane width criterion. The lane width criterion specifies that the lane width of a linear feature should be the closest to the median lane width (as defined by threshold range). If the result of the check returns yes, the linear feature is selected as the candidate key linear feature at 511, else it is discarded at 509 and another linear feature is picked for evaluation and step 507 repeats until all the linear features are evaluated.

Returning back to FIGS. 4A and 4B, at the key feature manipulation stage 403, the method 450 comprises generating 455 an extended key linear feature from the candidate key linear feature by subjecting the identified key feature to one or more geometrical manipulations. A non-limiting example of the geometrical manipulation includes linear extension of a graphical representation of the identified key linear feature. At 457, the method 450 comprises identifying a next link segment corresponding to a current link segment of the candidate key linear feature. This is realized, for example, by utilizing information from the map database 103a. The method 450 further comprises determining at least one intersection location between the extended key linear feature (generated at 455) and at least one of the current link segment corresponding to the candidate key linear feature or the next link segment identified at 457. A detailed explanation regarding each of the aforementioned stages and steps is discussed next with reference to one or more drawings.

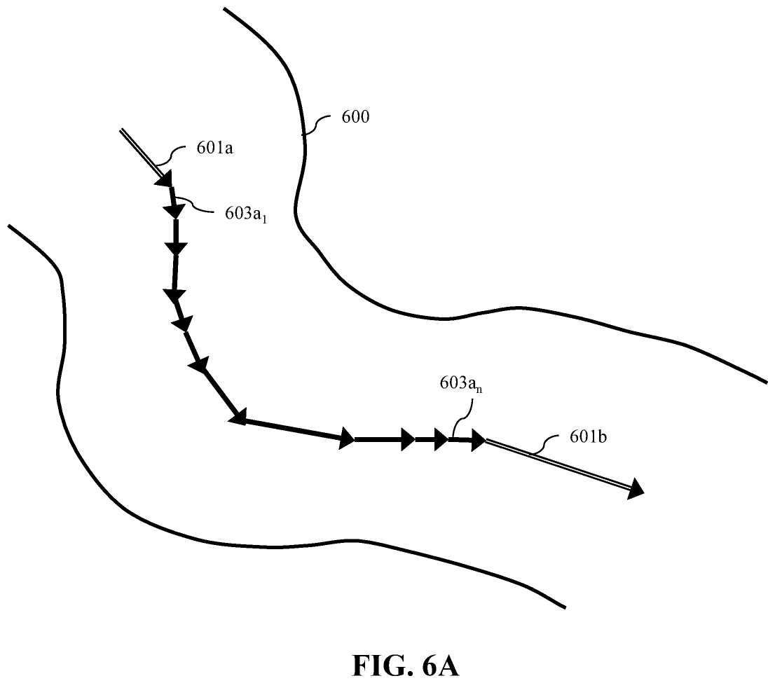

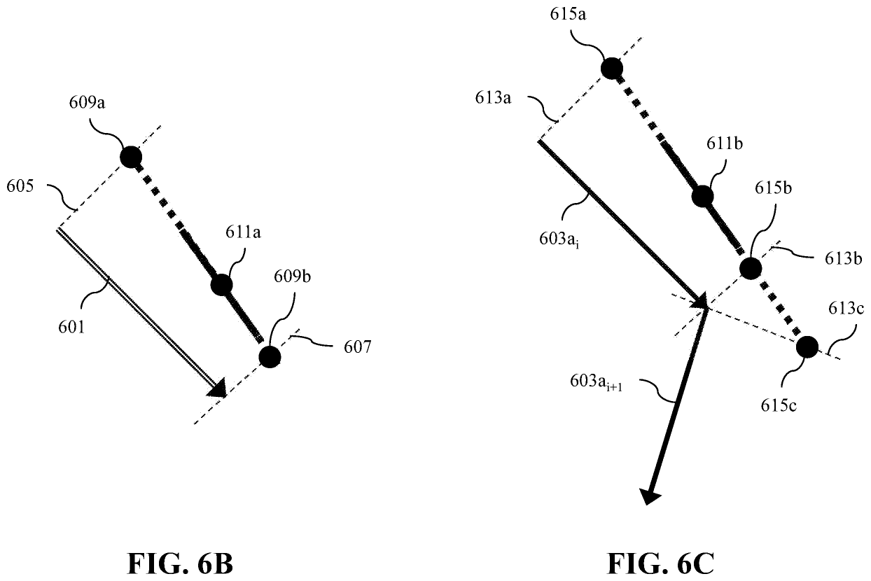

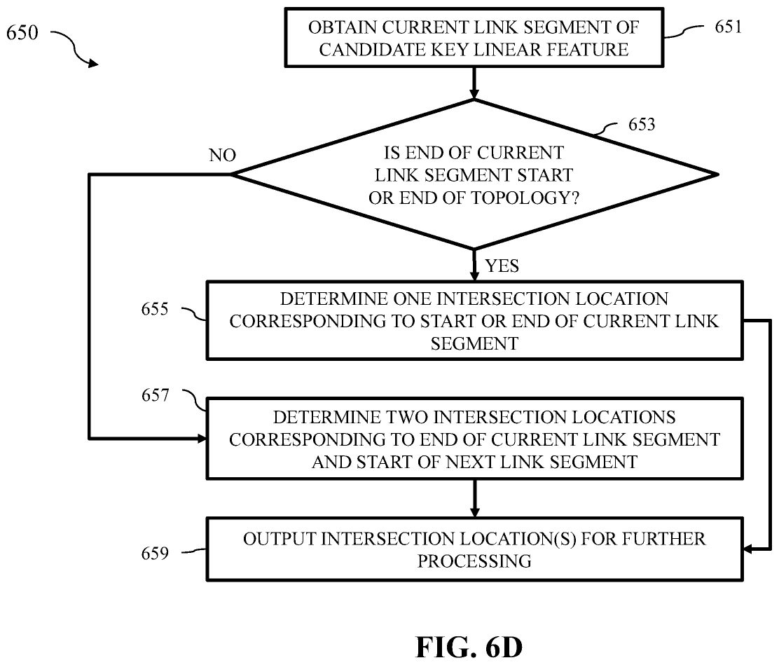

The key feature manipulation stage 403 and corresponding method step 455 is explained next in detail with reference to FIGS. 6A-6C. FIG. 6A illustrates a link level composition of the topology, in accordance with one or more example embodiments. A set of link segments 600 may connect two intersections in a region. The segments in the set of link segments 600 may be classified into two types—(i.) those whose end is the start/end of the topology (i.e. there is no corresponding upstream/downstream link segment) and (ii.) those which lie between such link segments whose end is the start/end of the topology. As illustrated in FIG. 6A, the end (arrowhead) of link segment 601a marks the start of the topology and the end of link segment 601b marks the end of the topology. As such these two link segments 601a and 601b fall under the first category (no upstream or downstream connecting link). Link segments 603a₁ to 603aₙ. are the links which have an upstream as well as downstream connecting link and therefore fall under the second category.

If the candidate key linear feature identified at step 453 of FIG. 4A corresponds to one of the link segments 601a or 601b, a different set of processing steps are executed for further processing while if the candidate key linear feature identified at step 453 of FIG. 4A corresponds to one of the link segments 603a₁ to 603aₙ, a still different set of processing steps are executed for further processing. The correspondence of a linear feature with a link segment may mean that for every linear feature there exists a corresponding link segment in the map data.

FIG. 6B illustrates a schema for generating an extended key linear feature for the topology, in accordance with an example embodiment. Specifically, FIG. 6B corresponds to the scenario where the candidate key linear feature identified at step 453 of FIG. 4A corresponds to one of the link segments 601a or 601b. For the sake of simplicity, the link segment corresponding to the identified candidate key linear feature 611a for this embodiment is designated as the current link segment 601. In order to perform key feature manipulation 403 on the candidate key linear feature 611a, the candidate key linear feature 611a is linearly extended towards each of the start and the end of the current link segment 601. The linear extension is performed by a finite distance such that a total length of the linear extension of the candidate key linear feature 611a is larger than a span of the current link segment 601. In this regard, the metes and bounds of the linear extension are defined by two lines (605 and 607) emanating from each of the start and end of the current link segment 601, the two lines (605 and 607) being perpendicular to the heading direction of the current link segment 601 at its start and end respectively. The linear extension of the candidate key linear feature 611a thus obtained, is selected as the extended key linear feature for further processing. Also, the linear extension of the candidate key linear feature in the manner described with reference to FIG. 6A, yields intersection locations 609a (between the extended linear feature for 611a and the perpendicular line 605 from start of the current link segment 601) and 609b (between the extended linear feature for 611a and the perpendicular line 607 from end of the current link segment 601).

FIG. 6C illustrates another schema for generating an extended key linear feature for the topology, in accordance with another example embodiment. Specifically, FIG. 6B corresponds to the scenario where the candidate key linear feature identified at step 453 of FIG. 4A corresponds to one of the link segments 603a₁ to 603aₙ. For the sake of simplicity, the link segment corresponding to the identified candidate key linear feature 611b for this embodiment is designated as the current link segment 603aᵢ. In order to perform key feature manipulation 403 on the candidate key linear feature 611b, the candidate key linear feature 611b is linearly extended towards each of the start and the end of the current link segment 603aᵢ. The linear extension is performed by a finite distance such that a total length of the linear extension of the candidate key linear feature 611b is larger than a span of the current link segment 603aᵢ. In this regard, the metes and bounds of the linear extension are defined by three lines (613a, 613b, and 613c) emanating from each of the start of the current link segment 603aᵢ, the end of the current link segment 603aᵢ, and the start of the next link segment 603aᵢ₊₁. The lines 613a and 613b are perpendicular to the heading direction of the current link segment 603aᵢ at its start and end respectively, and the line 613c is perpendicular to the heading direction of the next link segment 603aᵢ₊₁ at its start. The linear extension of the candidate key linear feature 611b between the lines 613a and 613c (shown as dashed), is selected as the extended key linear feature for further processing. Also, the linear extension of the candidate key linear feature 611b in the manner described with reference to FIG. 6C yields (i.) intersection location 615a (between the extended linear feature for 611b and the perpendicular line 613a from start of the current link segment 603aᵢ), (ii.) intersection location 615b (between the extended linear feature for 611b and the perpendicular line 613b from end of the current link segment 603aᵢ) and (iii.) intersection location 615c (between the extended linear feature for 611b and the perpendicular line 613c from start of the next link segment 603aᵢ₊₁).

In this manner, a method is devised for executing the logic described at step 459 of FIG. 4B for determining at least one intersection location between the extended key linear feature and a perpendicular from at least one of (i) the current link segment or (ii) the next link segment. FIG. 6D illustrates a flowchart of one such method 650 for determining at least one intersection location for generation of a new feature location, in accordance with a first example embodiment. At step 651, a current link segment corresponding to the identified candidate key linear feature is obtained. This may be achieved by sending a request to the map database 103a. Having obtained the current link (601 or 603aᵢ) of the candidate key linear feature, a check is performed at step 653 to determine if the end of the current link segment is a start or end of the topology. The check may be implemented by searching for an upstream link segment that is along an upstream of the current link, in the map data and searching for a downstream link segment that is along a downstream direction of the current link. The fact that the end of the current link segment is a start or end of the topology may be established by verifying if any of the upstream link segment or the downstream link segment is absent.

If the check at 653 returns a positive result, (that is the end of the current link segment is one of the start or end of the topology), the method 650 proceeds to step 655 where one intersection location corresponding to one of the start or the end of the current link segment is determined. For example, the intersection location determined at 655 may correspond to the intersection location 609a or 609b depending on whether the end of the current link segment is the start of the topology or the end of the topology, respectively. If, however, the check at 653 returns a negative result (that is the end of the current link segment is an intermediate link in the topology), the method 650 proceeds to step 657 where two intersection locations, one corresponding to the end of the current link segment and one corresponding to the start of the next link segment, are determined. For example, the two intersection locations determined at 657 may correspond to the intersection locations 615b and 615c. The determined intersection location(s) are output for further processing at 659 and the method 650 ends with transfer of control to method 450 of FIG. 4B.

Referring back to FIG. 4B, the method 450 further comprises generating 461 a new linear feature location based on the current link segment of the candidate key linear feature, the at least one intersection location determined at 459, and the map data. Two scenarios may arise in this context—one for the case where one intersection location is determined (i.e. scenario depicted in FIG. 6B) and one for the case where two intersection locations are determined (scenario depicted in FIG. 6C). In the context of the case where one intersection location is determined, referring to FIG. 6B, if it is determined that the candidate key linear feature is start or end of the topology, the process for generating new feature location proceeds as described next. Starting from the candidate key linear feature 611a, a line may be constructed using the most probable heading on the corresponding link segment 601. That line stops at the intersection location 609a of the perpendicular line 605 from the start location of the start segment (in this case link segment 601) or at the intersection location 609b of the perpendicular line 607 form the end location of the end segment (in this case link segment 601).

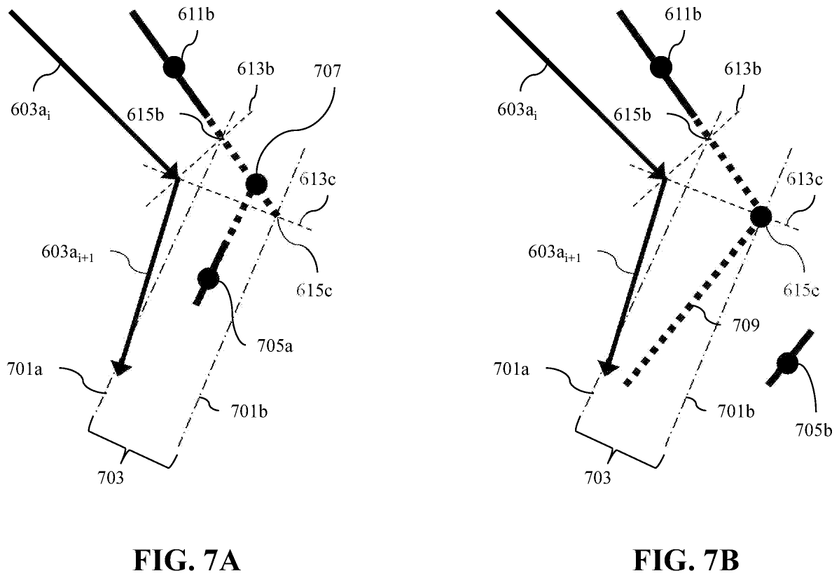

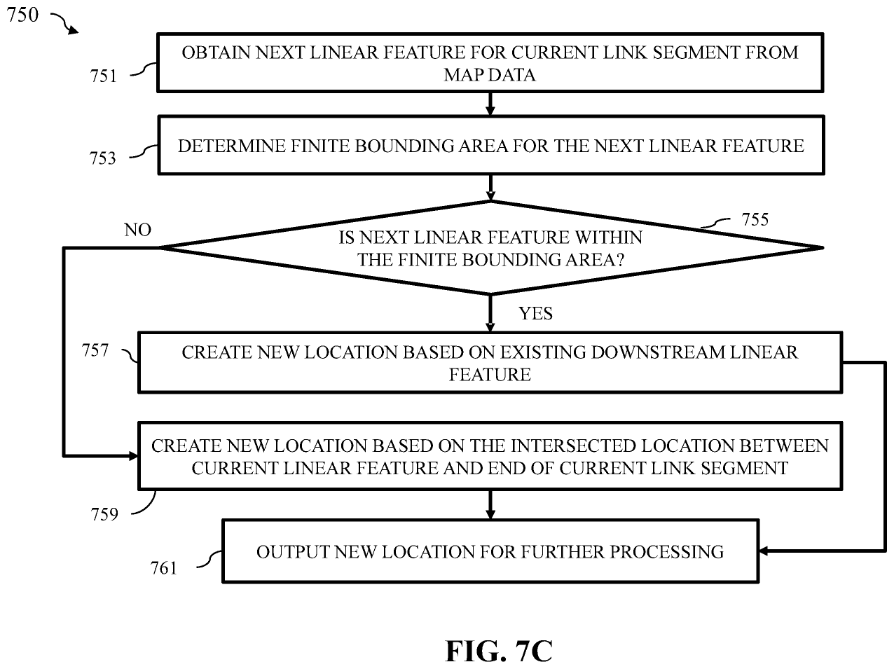

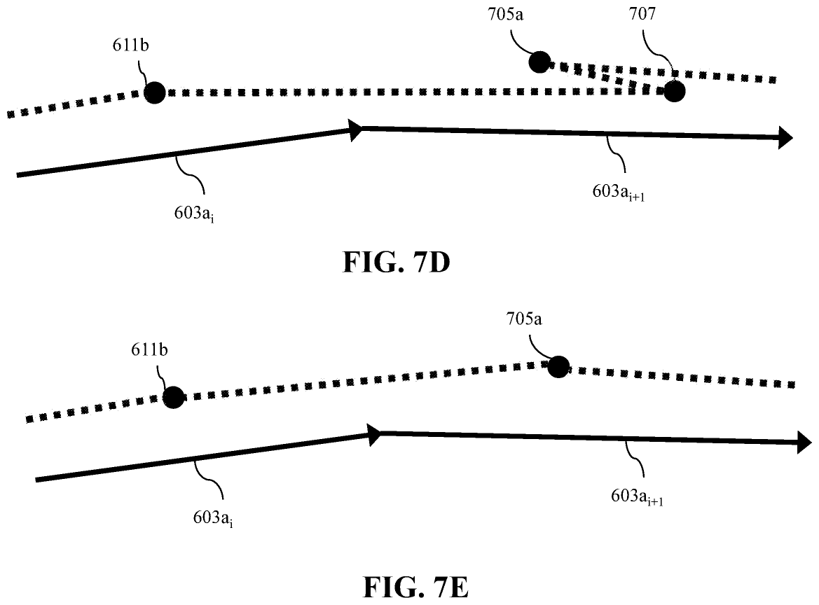

For the case where two intersection locations are determined, a detailed explanation regarding the new linear feature generation stage 411 and the step 461 is provided next in detail with reference to FIGS. 7A-7C. Having generated the new linear feature location, the method 450 further comprises updating the map data based on the new linear feature location. In this way, an updated map that better reflects all features is made available for providing navigation assistance and planning to users and devices.

FIG. 7A illustrates a schema for generating the new feature location, in accordance with an example embodiment. Also, FIG. 7B illustrates a schema for generating the new feature location, in accordance with another example embodiment. Specifically, FIGS. 7A and 7B correspond to the scenario where two intersection locations are generated at step 657. Referring to FIGS. 7A and 7B, using the map data of the topology, the next link segment 603aᵢ₊₁ corresponding to the current link segment 603aᵢ is obtained. A next linear feature (705a in FIGS. 7A and 705b in FIG. 7B) is then obtained from the map data of the next link segment 603aᵢ₊₁. Further, the two intersection locations 615b and 615c, generated by linear extension of the candidate key linear feature 611b, are utilized to produce two parallel lines 701a and 701b which extend along a heading direction of the next linear link segment 603aᵢ₊₁. The two parallel lines 701a and 701b along with the perpendicular 613c from the start of the next link segment 603aᵢ₊₁ define within themselves a finite bounding area 703. The location corresponding to the next linear feature (705a or 705b) is then read from the map data and a check regarding whether the next linear feature location, as read from the map data, lies within the finite bounding area 703, is performed.

As shown in FIG. 7A, the location (shown as black dot) of the next linear feature 705a lies within the finite bounding area 703. In this case, the next linear feature 705a is extended along the most probable heading on the next link segment 603aᵢ₊₁ towards the extension of the candidate key linear feature 611b to obtain an extended intersection location 707. The extended intersection location 707 is output as the new linear feature location corresponding to the next linear feature 705a. In this way, the two consecutive linear features 611b and 705a are connected at the extended intersection location 707 (i.e. the new linear feature location) and a proper representation of the linear features of the topology is made available for updating the map data. The data regarding the proper representation of the linear features of the topology is written over the existing map data for those features in the map database 103a to generate an updated map.

In another scenario where the location of the next linear feature does not lie within the finite bounding area is illustrated in FIG. 7B. As is shown in FIG. 7B, the location of the next linear feature 705b lies outside the finite bounding area 703. In this case, the intersection location 615c between the extension of the current linear feature 611b and the perpendicular 613c from the start of the next link segment 603aᵢ₊₁ is selected as the the new linear feature location corresponding to the next linear feature 705b. From the new linear feature location 615c, an extension 709 is produced along a heading direction of the next linear feature 705b to reconstruct the next linear feature 705b. In this way, the two consecutive linear features 611b and reconstructed 705b are connected and a proper representation of the linear features of the topology is made available for updating the map data. The data regarding the proper representation of the linear features of the topology is written over the existing map data for those features in the map database 103a to generate an updated map.

FIG. 7C illustrates a flowchart of a method 750 for generating the new feature location, in accordance with one or more example embodiments. The method 750 comprises obtaining at 751, a next linear feature for the current link segment from map data. In this regard, using the map data of the topology, firstly the next link segment corresponding to the current link segment of the candidate key linear feature is determined and the linear feature associated with the next link segment in the map data is read out as the next linear feature. The method further comprises at 753, determining a finite bounding area for the next linear feature. The finite bounding area is obtained in a manner similar to the one described previously with reference to FIGS. 7A and 7B. The method then comprises at 755, performing a check as to whether the next linear feature is within the finite bounding area. Towards this end, the finite bounding area determined at 753 may be defined in terms of Cartesian coordinates in a two dimensional space representing the topology. The location coordinates of the next linear feature may also be mapped on the same two dimensional space representing the topology. If the location coordinates of the next linear feature overlaps with the Cartesian coordinates of the finite bounding area, it is considered that the next linear feature is within the finite bounding area. If the location coordinates of the next linear feature do not overlap with the Cartesian coordinates of the finite bounding area, it is considered that the next linear feature is not within the finite bounding area.

Accordingly, if the check at 755 returns a positive result (i.e. the next linear feature is within the finite bounding area), the method 750 proceeds to step 757 at which a new location for the next linear feature is determined based on the existing linear feature in the downstream. This corresponds to the situation illustrated in FIG. 7A in which the next linear feature 705a is extended along the most probable heading on the next link segment 603aᵢ₊₁ towards the extension of the candidate key linear feature 611b to obtain an extended intersection location 707. The extended intersection location 707 is output as the new linear feature location corresponding to the next linear feature 705a.

However, if the check at 755 returns a negative result (i.e. the next linear feature is not within the finite bounding area), the method 750 proceeds to step 759 at which a new location is created based on the intersected location between the current linear feature and the end of the current link segment. This corresponds to the scenario illustrated in FIG. 7B in which the intersection location 615c between the extension of the current linear feature 611b and the perpendicular 613c from the start of the next link segment 603aᵢ₊₁ is selected as the the new linear feature location corresponding to the next linear feature 705b.

In either case, the generated new location is output at 761 for further processing. For example, the further processing may include filtering outliers or false positives and/or updating the map data. In some example embodiments, the filtering may be optional and the process may proceed to updating the map data. However, in some example embodiments, the filtering may be mandatory to improve the reliability of the map data. In such example embodiments, when connecting the linear features in two consecutive link segments, it may be possible that the intersected location between two linear features is not within the range (i.e. it is beyond the next linear feature along an axes of the Cartesian plane) of those two linear features. FIG. 7D illustrates a filtering schema for removing such outlier locations from the computation of the new feature location, in accordance with one or more example embodiments. As illustrated in FIG. 7D, in some scenarios, the intersection location 707 which is determined to be the new feature location, is not within the range of the current key linear feature 611b and the next linear feature 705a. In such scenarios, the determined intersection location is not included as the new feature location. In such cases the current key linear feature 611b is connected to the next linear feature 705a as shown in FIG. 7E and the processing continues for the rest of the linear features in the downstream. Thus, a point-in-line examination may be added as a filtering step to avoid corner cases in which case the intersection location is not selected as the new feature location. However, if the point in line examination indicates that the intersection location is within the range of the two linear features, the intersection location is choses as the new feature location and the two features are connected in the map data. In this manner the reconstructed next linear feature may be utilized to update the map data at step 463 of FIG. 4B.

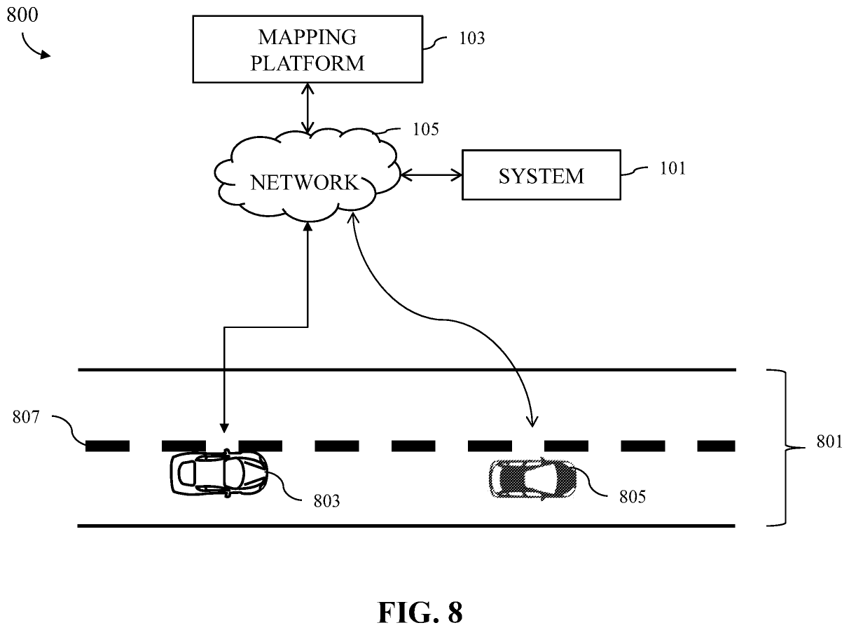

The update process of map data stored in the map database 103a in this manner ensures that high-quality, accurate and reliable data is available for all navigation related services using the mapping platform 103. For example, for guided or unaided navigation in a manual, semi-autonomous, or autonomous vehicle, the updated high quality map data performs a superior, accurate, safe, and reliable navigation, as compared to navigation services based on redundant faulty data. The use of such map data in a real-time working scenario is illustrated in FIG. 8.

FIG. 8 illustrates a diagrammatic representation of a working environment 800 of the system and the method for reconstructing a linear feature and updating the map data. The working environment 800 includes a road link 801 comprising a lane marking 807. Two vehicles, a vehicle 803 and 805 may traverse a route that includes the road link 801. In some example embodiments, the two vehicles 803 and 805 may not be traversing the route at the same time. Each of the two vehicles 803 and 805, may correspond to any one of an autonomous vehicle, a semi-autonomous vehicle, or a fully manually driven vehicle. As used herein, the autonomous vehicle may be a vehicle that is capable of sensing its environment and operating without human involvement. For instance, the autonomous vehicle may be a self-driving car and the like. As used herein, the ‘vehicle’ may include a motor vehicle, a non-motor vehicle, an automobile, a car, a scooter, a truck, a van, a bus, a motorcycle, a bicycle, a Segway, and/or the like.

In some example embodiments, the vehicle 805 may be a probe vehicle or a user vehicle capable of performing road observations. In some example embodiments, the vehicle 805 may be a dedicated vehicle for gathering data for development of the map data in the database 103a. In this regard, the vehicle may be equipped with a plurality of sensors such as a camera, a LiDAR sensor, an accelerometer, a gyroscope, a RADAR sensor, an RFID sensor, and the like. Using any or a combination of the plurality of sensors, the vehicle 805 may be configured to obtain sensor data associated with detection of the lane markings 807. This data may be referred to as road observation data.

In some example embodiments, the vehicle 807 may be a passenger vehicle for carrying passengers or cargo. Navigation control of the vehicle 807 may be based on data and/or instructions provided by the mapping platform 103. In this regard, the vehicle may be equipped with equipment/circuitry configured to execute and run applications/programs such as a navigation application. Thus, the vehicle 807 may at least serve as a beneficiary of the map data provided by the mapping platform 103.

Vehicle 805 may transmit the road observation data to the mapping platform 103, via the network 105. The road observation data may be transmitted in any suitable manner such as sequentially or as batch uploads. Upon receipt of the road observation data, the mapping platform 103 may invoke the system 101, which may be an on-premises or cloud-based system, and thus may be integrated within the mapping platform 103 or connected to the mapping platform 103 via the network 105. In either case, the system 101 comprises one or more processors and associated circuitry for processing on the road observation data.

The system 101 may execute the process for reconstructing linear feature and updating the map data in a manner similar to the ones described with reference to FIGS. 4A-7D. The system 101 may be configured to read as well as write data in the mapping database 103a of the mapping platform 103. In some example embodiments, the system may send control instructions to the mapping platform 103 to update the data in the map database 103a. As a result of the update of map data in the map database 103a, the map database is freed of any inaccuracy with respect to labelling or localisation of linear features on the map. The updated map data may be provided to user equipment serving as beneficiaries in any suitable manner such as on request or through a push update mechanism.

In some example embodiments, vehicle 803 may request for navigation assistance from the mapping platform 103. In some example embodiments, vehicle 803 may request for the map data of the region instead and perform navigation assistance by itself. In some other embodiments, the vehicle may not request the map data but may receive the updated map data through a push mechanism and maintain a local cache of it. In either case, the vehicle 803 benefits from the updated map data by generating precise navigation assistance Some non-limiting examples of the navigation related services include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

In some embodiments, the vehicles 803 and/or 805, may themselves include the system 101 for performing the map data update processing. Further, the number of vehicles and the number of lane markings in FIG. 8 are limited to two, only for the purpose of brevity of explanation. However, in practical implementation, any number of vehicles, and any number of lane markings may be used, without deviating from the scope of the present disclosure.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A system for updating a map, comprising:
a memory configured to store instructions; and
one or more processors configured to execute the instructions to:
obtain map data associated with a topology and sensor data corresponding to a plurality of linear features on the topology, wherein the topology comprises a plurality of link segments;
identify a candidate key linear feature from the plurality of linear features, based on one or more of the map data or at least one characteristic associated with the plurality of linear features, wherein the candidate key linear feature is associated with a current link segment of the plurality of link segments;
generate an extended key linear feature from the candidate key linear feature by one or more geometrical manipulations of the candidate key linear feature relative to one or more of a start or an end of the current link segment;
identify a next link segment corresponding to the current link segment of the candidate key linear feature, based on the map data;
determine at least one intersection location between the extended key linear feature and a perpendicular from at least one of (i) the current link segment or (ii) the next link segment;
generate a new linear feature location based on the current link segment, the at least one intersection location, and the map data; and
update the map data based on the new linear feature location.

2. The system of claim 1, wherein to identify the candidate key linear feature, the one or more processors are configured to:
aggregate the plurality of linear features according to heading data and location data of each linear feature of the plurality of linear features;
determine a lateral distance between each pair of the aggregated linear features; and
select a linear feature among the plurality of linear features that satisfies a lane width criterion as the candidate key linear feature, based on the lateral distance between each pair of the aggregated linear features.

3. The system of claim 1, wherein to generate the extended key linear feature, the one or more processors are configured to:
linearly extend the candidate key linear feature to at least one of the start or the end of the current link segment of the candidate key linear feature by a finite distance such that a total length of the linear extension of the candidate key linear feature is larger than a span of the current link segment; and
select the linear extension of the candidate key linear feature as the extended key linear feature.

4. The system of claim 1, wherein to determine the at least one intersection location between the extended key linear feature and the perpendicular from the at least one of (i.) the at least one of the current link segment or (ii.) the next link segment, the one or more processors are configured to:
search, for an upstream link segment that is along an upstream heading of the current link segment, in the map data; and
search, for a downstream link segment that is along a downstream heading of the current link segment, in the map data.

5. The system of claim 4,
wherein
if the upstream link segment is absent, the one or more processors are further configured to determine, a first intersection location between a first perpendicular from the start of the current link segment and the extended key linear feature, as the at least one intersection location, wherein the first perpendicular is normal to a heading direction at the start of the current link segment, or
if the downstream link segment is absent, the one or more processors are further configured to determine, a second intersection location between a second perpendicular from the end of the current link segment and the extended key linear feature, as the at least one intersection location, wherein the second perpendicular is normal to a heading direction at the end of the current link segment, and
wherein the one or more processors are further configured to output one of the first intersection location or the second intersection location as the at least one intersection location.

6. The system of claim 1, wherein the one or more processors are further configured to:
determine a first intersection location between a first perpendicular from an end of the current link segment to the extended key linear feature, wherein the first perpendicular is normal to a heading direction of the current link segment;
determine a second intersection location between a second perpendicular from a start of the next link segment to the extended key linear feature, wherein the second perpendicular is normal to a heading direction of the next link segment; and
output the first intersection location and the second intersection location as the at least one intersection location.

7. The system of claim 6, wherein the one or more processors are further configured to:
determine a next linear feature associated with the next link segment, based on the map data;
determine a finite bounding area defined between a bounding box having parallel sides respectively passing through the first intersection location and the second intersection location, wherein each of the parallel sides extends along a heading direction of the next link segment; and
determine a location corresponding to the next linear feature, based on the map data.

8. The system of claim 7, wherein the one or more processors are further configured to:
generate an extended next linear feature from the next linear feature by linear extension of the next linear feature towards the extended key linear feature, based on the location corresponding to the next linear feature being within the finite bounding area; and
determine a third intersection location of the extended next linear feature and the extended key linear feature as the new linear feature location.

9. The system of claim 7, wherein the one or more processors are further configured to select the second intersection location as the new linear feature location, based on the location corresponding to the next linear feature being outside the finite bounding area.

10. A computer implemented method for updating a map, comprising:
obtaining map data associated with a topology and sensor data corresponding to a plurality of linear features on the topology, wherein the topology comprises a plurality of link segments;
identifying a candidate key linear feature from the plurality of linear features, based on one or more of the map data or at least one characteristic associated with the plurality of linear features, wherein the candidate key linear feature is associated with a current link segment of the plurality of link segments;
generating an extended key linear feature from the candidate key linear feature by one or more geometrical manipulations of the candidate key linear feature relative to one or more of a start or an end of the current link segment;
identifying a next link segment corresponding to the current link segment, based on the map data;
determining at least one intersection location between the extended key linear feature and a perpendicular from at least one of (i.) the current link segment or (ii.) the next link segment;
generating a new linear feature location based on the current link segment, the at least one intersection location, and the map data; and
updating the map data based on the new linear feature location.

11. The method of claim 10, wherein for identifying the candidate key linear feature, the method further comprises:
aggregating the plurality of linear features according to heading data and location data of each linear feature of the plurality of linear features;
determining a lateral distance between each pair of the aggregated linear features; and
selecting a linear feature among the plurality of linear features that satisfies a lane width criterion as the candidate key linear feature, based on the lateral distance between each pair of the aggregated linear features.

12. The method of claim 10, wherein for generating the extended key linear feature, the method further comprises:
linearly extending the candidate key linear feature to at least one of the start or the end of the current link segment of the candidate key linear feature by a finite distance such that a total length of the linear extension of the candidate key linear feature is larger than a span of the current link segment; and
selecting the linear extension of the candidate key linear feature as the extended key linear feature.

13. The method of claim 10, wherein for determining the at least one intersection location between the extended key linear feature and the perpendicular from (i.) the at least one of the current link segment or (ii.) the next link segment, the method further comprises:
searching, for an upstream link segment that is along an upstream heading of the current link segment, in the map data; and
searching, for a downstream link segment that is along a downstream heading of the current link segment, in the map data.

14. The method of claim 13,
wherein
if the upstream link segment is absent, the method further comprises determining a first intersection location between a first perpendicular from the start of the current link segment and the extended key linear feature as the at least one intersection location, wherein the first perpendicular is normal to a heading direction at the start of the current link segment, or
if the downstream link segment is absent, the method further comprises determining a second intersection location between a second perpendicular from the end of the current link segment and the extended key linear feature as the at least one intersection location, wherein the second perpendicular is normal to a heading direction at the end of the current link segment, and
wherein the method further comprises outputting one of the first intersection location or the second intersection location as the at least one intersection location.

15. The method of claim 10, further comprising:
determining a first intersection location between a first perpendicular from an end of the current link segment to the extended key linear feature, wherein the first perpendicular is normal to a downstream heading direction of the current link segment;
determining a second intersection location between a second perpendicular from a start of the next link segment to the extended key linear feature, wherein the second perpendicular is normal to a downstream heading direction of the next link segment; and
outputting the first intersection location and the second intersection location as the at least one intersection location.

16. The method of claim 15, further comprises:
determining a next linear feature associated with the next link segment, based on the map data;
determining a finite bounding area defined between a bounding box having parallel sides respectively passing through the first intersection location and the second intersection location, wherein each of the parallel sides extends along a heading direction of the next link segment; and
determining a location corresponding to the next linear feature, based on the map data.

17. The method of claim 16, further comprising:
generating an extended next linear feature from the next linear feature by linear extension of the next linear feature towards the extended key linear feature, based on the location corresponding to the next linear feature being within the finite bounding area; and
determining a third intersection location of the extended next linear feature and the extended key linear feature as the new linear feature location.

18. The method of claim 16, further comprising selecting the second intersection location as the new linear feature location, based on the location corresponding to the next linear feature being outside the finite bounding area.

19. A computer program product comprising at least one non-transitory computer-readable storage medium having stored thereon computer-executable program code instructions which when executed by a computer, cause the computer to carry out operations for updating a map, the operations comprising:
obtaining map data associated with a topology and sensor data corresponding to a plurality of linear features on the topology, wherein the topology comprises a plurality of link segments;
identifying a candidate key linear feature from the plurality of linear features, based on one or more of the map data or at least one characteristic associated with the plurality of linear features, wherein the candidate key linear feature is associated with a current link segment of the plurality of link segments;
generating an extended key linear feature from the candidate key linear feature by one or more geometrical manipulations of the candidate key linear feature relative to one or more of a start or an end of the current link segment;
identifying a next link segment corresponding to the current link segment, based on the map data;
determining at least one intersection location between the extended key linear feature and a perpendicular from at least one of (i.) the current link segment or (ii.) the next link segment;
generating a new linear feature location based on the current link segment of the candidate key linear feature, the at least one intersection location, and the map data; and
updating the map data based on the new linear feature location.

20. The computer program product of claim 19, wherein for identifying the candidate key linear feature, the operations further comprise:
aggregating the plurality of linear features according to heading data and location data of each linear feature of the plurality of linear features;
determining a lateral distance between each pair of the aggregated linear features; and
selecting a linear feature among the plurality of linear features that satisfies a lane width criterion as the candidate key linear feature, based on the lateral distance between each pair of the aggregated linear features.
